(19) United States
(12) Patent Application Publication
(10) Pub. No.: US 2025/0209301 A1
(43) Pub. Date: Jun. 26, 2025

(54) GENERATING GRAPH MODEL

(71) Applicant: Sage Global Services Limited, Newcastle upon Tyne (GB)

(72) Inventors: Yu-Cheng TSAI, Redmond, WA (US); Daniel KAPLAN, New Brunswick, NJ (US); Jeremiah EDWARDS, Boulder, CO (US)

(73) Assignee: Sage Global Services Limited, Newcastle upon Tyne (GB)

(21) Appl. No.: 18/394,446

(22) Filed: Dec. 22, 2023

(51) Int. Cl. G06N 3/0464

(52) U.S. Cl. CPC G06N 3/042

(57) ABSTRACT

A computer implemented method generates a graph model for performing a data processing operation associated with an accounting task. Training instruction data is received from an interface identifying a subset of nodes and edges, the edges interconnecting the nodes, from a network graph representing a plurality of relationships, and an output variable associated with the accounting task for the trained graph model to predict. A subset of nodes and edges are retrieved from the network graph. One or more accounting data records associated with one or more of the subset of nodes and edges are retrieved. A training graph is generated with the retrieved subset of nodes and edges supplemented by the accounting data. A graph model is trained to predict the output variable using the training graph. The training graph is deployed to a system for performing the data processing operation associated with the accounting task.

### TECHNICAL FIELD

The present invention relates to techniques for training graph models.

### BACKGROUND

Recent advances in artificial intelligence (AI) have sparked interest across various sectors. One area that has seen considerable progress is the development of large language models (LLMs). Applications of these models are being developed across a diverse range of settings from healthcare to retail.

While much recent attention in the field of artificial intelligence has been focused on Large Language Models (LLMs), another significant area of development lies in graph models. LLMs primarily operate on continuous sequences of tokens, such as words in text, to understand and generate human language. In contrast, graph models employ a fundamentally different data structure, using nodes and edges to represent discrete entities and their interrelationships. This distinction allows graph models to effectively capture and analyse complex networks and interactions, a feature that is particularly advantageous in scientific sectors. For instance, graph models have been extensively applied in the exploration of new drugs or chemical compounds, where understanding intricate relationships between different molecular entities is important. Other areas where graph models are used include transportation and urban planning (traffic prediction and management), cybersecurity (network intrusion detection), telecommunication (network optimization of routing), social network (community detection, or influence prediction), healthcare (drug discovery)

While graph models are mainly employed to explore complex physical systems, such as the behaviour of particles and molecules, they also hold promise for systems involving abstract relationships, such as those involving parties connected by commercial relationships. For example, graph models could potentially find utility in commercial settings, aiding in all manner of tasks associated with parties connected via relationships that can be modelled as a graph such as data processing and data classification tasks, fraud detection and resource allocation.

However, integrating graph-based techniques into business or accounting systems—such as those designed for managing process such as accounts receivable (AR) and accounts payable (AP)—poses challenges. These accounting systems usually manage data in a tabular or ledger format. Consequently, without changes to how accounting data is managed or stored, it is not immediately obvious how graph models could be applied to perform useful tasks in systems that use this data. It would be extremely difficult to change the way most accounting data is stored and how transactions are recorded, due to regulatory constraints and well-established accounting practices.

Accordingly, despite the potential of graph models to undertake tasks underpinned by complex abstract relationships (e.g. between vendors and customers), adapting this technology to aid the performance of accounting tasks remains a difficult problem.

### SUMMARY OF THE INVENTION

In accordance with a first aspect of the invention, there is provided a computer implemented method of generating a graph model for performing a data processing operation associated with an accounting task. The method comprises the steps of:
a) receiving training instruction data from an interface identifying a subset of nodes and edges, said edges interconnecting said nodes, from a network graph representing a plurality of relationships, and an output variable associated with the accounting task for the trained graph model to predict;
b) retrieving the subset of nodes and edges from the network graph;
c) retrieving one or more accounting data records associated with one or more of the subset of nodes and edges;
d) generating a training graph comprising the retrieved subset of nodes and edges supplemented by the accounting data;
e) training a graph model to predict the output variable using the training graph, and
f) deploying the training graph to a system for performing the data processing operation associated with the accounting task.

Optionally, each node is representative of an entity.

Optionally, each edge is representative of a relationship or interaction between entities associated with nodes that the edge interconnects.

Optionally, each node has a type, said type indicative of a characteristic associated with entity of which the node is representative.

Optionally, each edge has a type, said type indicative of a characteristic associated with the relationship of interaction with which the edge is associated.

Optionally, the retrieved accounting data records define further accounting properties associated with the entities to which the nodes relate.

Optionally, the retrieved accounting data records define further accounting properties associated with the interactions or relationships between entities to which the edges relate.

Optionally, the entity to which each node relates is one of a party or an accounting data object.

Optionally, the training instruction data specifies parameters of the graph model and step e) comprises a preliminary graph model configuration step comprising setting one or more parameters of the graph model in accordance with the graph model configuration data.

Optionally, the preliminary graph model configuration step further comprises configuring an input of the graph model in accordance with the subset of nodes and edges defined in the training instruction data.

Optionally, the preliminary graph model configuration step further comprises configuring an output of the graph model in accordance with the output variable defined in the training instruction data.

Optionally, the training instruction data identifies the subset of nodes and edges by specifying one or more node types and one or more edge types and the step of retrieving the subset of nodes and edges from the network graph comprises retrieving nodes and edges of the specified types from the network graph.

Optionally, the interface runs on a computing device configured to receive the training instruction data from an operative.

Optionally, the graph model is one of: a graph neural network; graph convolutional network; graph attention network; graph autoencoder; graph recurrent neural network; graph generative adversarial network; Bayesian graph neural network; causal graph network; differentiable graph network; symbolic graph network; relational graph network.

In accordance with a second aspect of the invention, there is provided a computer system for generating a graph model for performing a data processing operation, associated with an accounting task. The system comprises a training graph generation module and a graph model training module. The training graph generation module is configured to: receive training instruction data from an interface identifying a subset of nodes and edges, said edges interconnecting said nodes, from a network graph representing a plurality of relationships, and an output variable associated with the accounting task for the trained graph model to predict; retrieve from data storage the subset of nodes and edges from the network graph; retrieve from data storage one or more accounting data records associated with one or more of the subset of nodes and edges, and generate a training graph comprising the retrieved subset of nodes and edges supplemented by the accounting data. The graph model training module is configured to receive the training graph and train a graph model to predict the output variable using the training graph, said training graph thereby deployable to a system for performing the data processing operation associated with the accounting task.

Optionally, each node is representative of an entity.

Optionally, each edge is representative of a relationship or interaction between entities associated with nodes that the edge interconnects.

Optionally, each node has a type, said type indicative of a characteristic associated with entity of which the node is representative.

Optionally, each edge has a type, said type indicative of a characteristic associated with the relationship of interaction with which the edge is associated.

Optionally, the retrieved accounting data records define further accounting properties associated with the entities to which the nodes relate.

Optionally, the retrieved accounting data records define further accounting properties associated with the interactions or relationships between entities to which the edges relate.

Optionally, the entity to which each node relates is one of a party or an accounting data object.

Optionally, the training instruction data specifies parameters of the graph model, and the graph model training module is configured to perform a preliminary graph model configuration procedure comprising setting one or more parameters of the graph model in accordance with the graph model configuration data.

Optionally, the preliminary graph model configuration procedure further comprises configuring an input of the graph model in accordance with the subset of nodes and edges defined in the training instruction data.

Optionally, the preliminary graph model configuration procedure further comprises configuring an output of the graph model in accordance with the output variable defined in the training instruction data.

Optionally, the training instruction data identifies the subset of nodes and edges by specifying one or more node types and one or more edge types and the step of retrieving the subset of nodes and edges from the network graph comprises retrieving nodes and edges of the specified types from the network graph.

Optionally, the system further comprises a computing device on which the interface runs and configured to receive the training instruction data from an operative.

Optionally, the graph model is one of a graph neural network; graph convolutional network; graph attention network; graph autoencoder; graph recurrent neural network; graph generative adversarial network; Bayesian graph neural network; causal graph network; differentiable graph network; symbolic graph network; relational graph network.

In accordance with a third aspect of the invention, there is provided a computer program which when run on a computing system controls the computing system to perform a method according the second aspect.

In accordance with embodiments of the invention, a technique is provided whereby an operative, for example an AI expert, can identify a subset nodes and edges from a network graph, for example a network graph representing relationships between entities who use an accounting system (for example customers and vendors) and associated data objects (for example invoices and purchase orders). A variable associated with an accounting task is similarly identified, typically a variable which is thought to or known to correlate with certain properties of the subset of nodes and edges.

The subset of nodes and edges are then used to generate a training graph which is supplemented with relevant accounting data relating to the entities and relationships associated with the subset of nodes and edges. The training graph is then used to train a graph model to predict the output variable. When the model is trained, it can then be deployed in a system to perform the accounting task.

Various further features and aspects of the invention are defined in the claims.

### BRIEF DESCRIPTION OF THE DRAWINGS

Embodiments of the present invention will now be described by way of example only with reference to the accompanying drawings where like parts are provided with corresponding reference numerals and in which:

FIG. 1 provides a simplified schematic diagram in accordance with an example of the invention;

FIG. 2 provides a diagram depicting a process in accordance with an example of the invention;

FIG. 3 provides a diagram depicting nodes and edges and how they can be connected to as part of a training graph in accordance an illustrative example of the invention, and

FIG. 4 provides a simplified schematic diagram depicting an example implementation of an embodiment of the invention.

### DETAILED DESCRIPTION

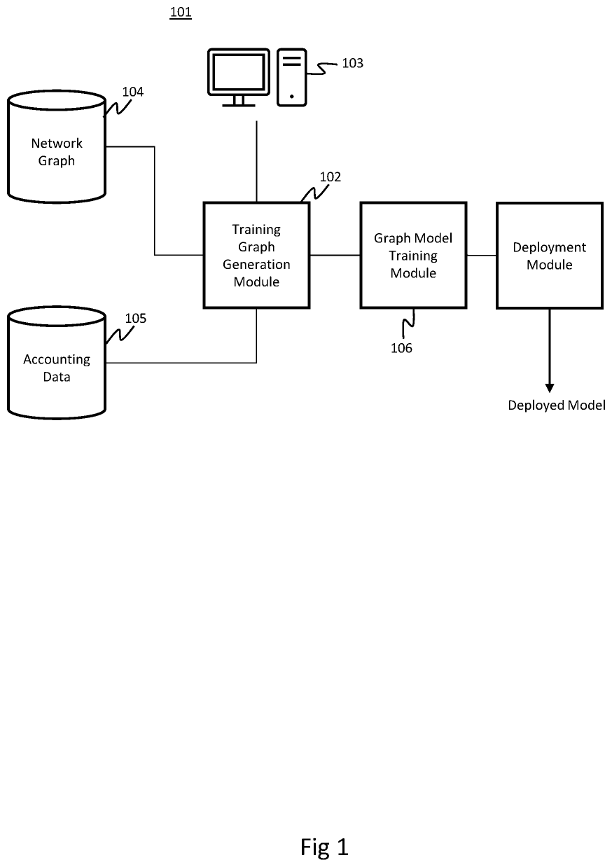

FIG. 1 provides a simplified schematic diagram depicting a system 101 for generating and deploying AI graph models for performing data processing operations associated with accounting tasks in accordance with certain embodiments of the invention.

Examples of the invention find particular utility in large software systems such as widely used financial and business management platforms which are configured to process accounting data to perform accounting tasks such as generating financial statements and reports, accounts receivable/payable management, general ledger and journal entry posting, cash flow analysis, tax preparation and filing, audit support, payroll processing, invoice creation and tracking, expense reporting, budgeting and forecasting, fixed asset tracking, and more.

The system 101 comprises a training graph generation module 102 which is connected to a user interface 103. The training graph generation module 102 is further connected to a first database 104 on which is stored a network graph and a second database 105 on which is stored accounting data. The training graph generation module 102 is further connected to a graph model training module 106 which is connected to a deployment module 107.

The network graph stored on the first database 104 comprises a data graph formed from a plurality of nodes interconnected via a plurality of edges. In this example, the nodes of the data graph represent entities associated with an accounting system, such as specific parties (e.g., people, groups of people, organisations, groups of organisations, and so on) or important data objects (e.g., invoices, purchase orders, financial reports, transaction records, account ledgers, budget documents, tax filings, audit logs, expense claims, reconciliation statements, loan amortization schedules, credit and debit notes, and so on). The nodes may have a type corresponding to characteristic of the entity they represent. For example, a node representing a party may have a “customer” type or “vendor” type, and a node representing a data object may have an “invoice” type or “purchase order” type.

Similarly, the edges represent relationships and interactions between the entities represented by the nodes. The edges may also have a type corresponding to a characteristic of the relationship or interaction to which edge represents. For example, a “customer” type node may be connected to a “vendor” type node with an edge with a “buys from” type. Similarly, an “invoice” type node may be connected to a “vendor” type node with an edge with a “sends” type edge and connected to a node with a customer type by an edge with a “receives” type.

The accounting data stored in the second database 105 comprises further data defining further accounting properties of the entities represented by the nodes of the network graph, and further data defining further accounting properties of the relationships/interactions represented by the edges of the network graph.

For example, the accounting data may comprise accounting data records associated with properties of customer and vendor parties represented by “customer” type nodes and “vendor” type nodes, such as: “type of business”, “organisation location”, “organisation name”, “organisation size”, and so on.

Further, the accounting data may comprise accounting data records associated with properties of data objects represented by “invoice” type nodes and “purchase order” type nodes such as: “issue date”, “transaction amount”, general ledger (GL) codes, and so on.

Further, for example, the accounting data may comprise data records associated with properties of relationships represented by “sends” or “receives” type edges of the network graph, such as “date of sending”, “date of receipt”, “method of sending”, “method of receipt”, and so on.

The accounting data may comprise data records associated with properties of relationships represented by “buys from” or “sells to” type edges of the network such as “date of relationship commencement”, and so on.

In use, the system 101 is configured to facilitate a technique whereby data from the first database 104 and data from the second database 105 can be selected and then combined to form a training graph. This training graph can then be used to train a graph model to perform a data processing operation associated with a particular accounting task.

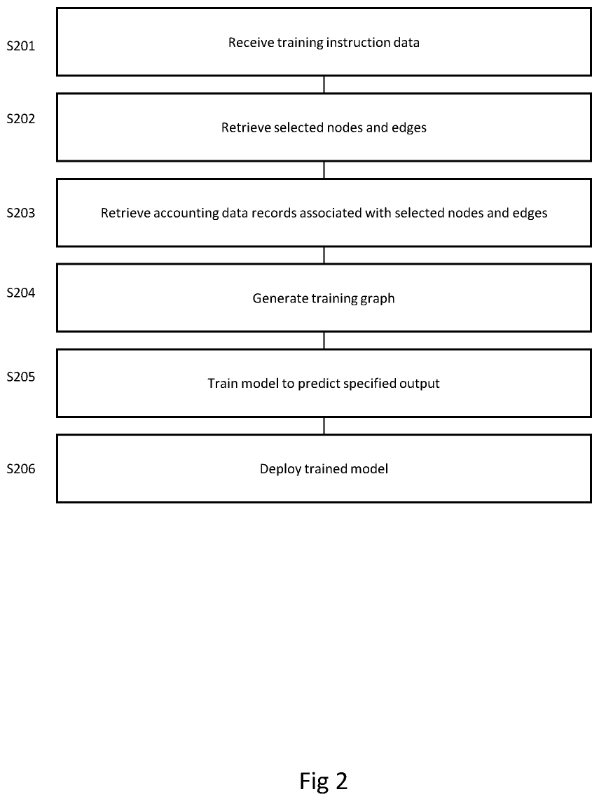

Operation of the system 101 is described in further detail with respect to the process flow depicted in FIG. 2.

The user interface 103, provided by a suitable computing system, provides an interface via which an operative, for example an AI specialist, can provide training instruction data to configure and train a graph model to perform a particular accounting processing task.

At a first step, S201, this training instruction data is received via the user interface 103 and communicated to the training graph generation module 102.

Typically, the training instruction data comprises training graph selection data and graph model configuration data.

The training graph selection data comprises data specifying, for example a subset of the node types and edge types from the network graph stored on the first database 104, and data specifying certain accounting properties relating to the selected nodes and edges stored in the second database 105. From this data, a training graph can be generated which can be used to train a graph model to perform a data processing operation.

The graph model configuration data comprises data specifying how a graph model needs to be configured to be trained to perform a specific accounting task. The graph model configuration data typically comprises graph model parameters specifying, in particular, the output variable to be produced by the graph model (e.g. a data type of the target variable that the graph model is to predict). In typical examples, the data type is some form of accounting property.

At a second step S202, the training graph generation module 102 is configured to retrieve from the first database 104 all the nodes of the selected node type, and all the edges of the selected edge type that connect these nodes.

At a third step S203, the training graph generation module 102 is configured to retrieve the selected accounting data records corresponding to the specified accounting properties of the selected node types and selected edge types specified by the training graph selection data.

At a fourth step S204, the training graph generation module 102 is configured to generate a training graph from the selected node types and edge types and the associated retrieved accounting data records. Specifically, the training graph generation module 102 is configured to generate a training graph comprising all the retrieved nodes and edges of the selected types where each node and edge is supplemented with the relevant accounting data records retrieved at the third step S203. In other words, this supplementing involves assigning data attributes to each node and edge, wherein these data attributes are derived from and representative of the accounting data, thereby integrating this data directly into the structure of the graph to provide context for each element within the graph.

At a fifth step S205, the training graph is forwarded from the training graph generation module 102 to the graph model training module 106 along with the graph model configuration data. The graph model training module 106 is then configured to undertake a training protocol to configure a graph model using the graph model configuration data, and then train the graph model using the training graph.

The training protocol can be undertaken in any suitable way.

In one example, the training protocol comprises two phases: a preliminary graph model configuration phase and a graph model training phase.

During the graph model configuration phase, the training instruction data is used to configure the parameters of the graph model.

For example, an input embedding layer of the graph model can be configured based on the features of the training graph specified in the training graph selection data (e.g. the node types, edge types and the accounting data records supplementing each node and edge). Further, the output layer of the graph model can be configured based on the required output variable of the graph model specified in the graph configuration data.

The graph configuration data may specify further parameters of the graph which are set during the preliminary graph model configuration phase. These further parameters may include, for example, setting the number of units (neurons) in a Graph Convolutional Network (GCN) layer, the type of activation function, and other related hyperparameters; the configuration of further layers after the GCN layer, such as fully connected layers including specifying their size, activation functions, and other parameters; configuring the nature of the output layer such as selecting a SoftMax layer or linear layer; selecting an appropriate loss function, for example a cross-entropy loss function, or a regression based function; and setting parameters of an optimisation algorithm for updating the graph model's weight such as its learning rate.

During the graph model training phase, the training graph is then used to train the configured graph model to optimally predict the output variable defined in the graph model configuration data. As the skilled person will understand, this can be done in any suitable way and typically in depends on the type of graph model being trained. Typically search training involves iteratively applying forward propagation and backward propagation to adjust the weights of one or more graph layers of the graph model to minimise a loss function.

At a sixth step S206, the trained model is deployed, typically to an accounting system configured to perform the accounting task.

Data processing tasks associated with this deployment are undertaken by the deployment module 107. For example, the deployment module may take data associated with the trained graph model such as weights and other parameters and package them into a format that can be used by the system implementing the model. It may then communicate the packaged model, in a suitable format, to an accounting services system or other infrastructure where the model will be deployed.

A simple example of the technique is now provided.

In certain settings, it may be suspected that when a vendor sends an invoice to a customer, the GL code of the invoice correlates with a combination of the nature of the business of other parties with whom the vendor has “sells to” relationship, and the nature of the business of other parties with whom the customer has “buys from” relationship. Consequently, a combination of vendor relationships and customer relationships can be used to predict a GL code of an invoice sent from a vendor to a customer.

In such an example, an AI specialist may seek to take advantage of this correlation to deploy a graph model which performs a data processing operation of allocating GL codes to invoice data objects associated with an accounts receivable accounting task.

In such an example, the machine leaning specialist can input training graph selection data to the user interface 103 specifying nodes and edges from the first database 104 and accounting data from the second database 105 which is relevant to this correlation.

For example, via the user interface 103, the AI specialist may specify all nodes of type “vendor”; all nodes of the type “customer”; all connected nodes of type “invoice”, all edges of type “sells to”; all edges of type “buys from” that connect the “vendor” and “customer” type nodes, along with all “sends to” type edges and “receives from” type edges that connect “invoice” type nodes with “vendor” and “customer” type nodes.

Further, via the user interface 103, the AI specialist may specify accounting data records stored in the second database 105 specifying GL code data records of all of the invoices corresponding to the “invoice” type nodes, and “business type” data records associated with the all the vendor and customer parties represented in the network graph.

As described above, this training graph selection data is then communicated from the user interface 103 to the training graph generation module 102, which at the second step S202 and third step S203 respectively, retrieves the relevant data from the first database 104 and second database 105.

At a fourth step, the training graph generation module 102 generates a training graph from this retrieved data.

As will be understood, this training graph is a subset of the network graph stored in the first database 104 formed of the nodes and edges specified in the training graph selection data, with the relevant nodes and edges supplemented with the accounting data specified in the training graph selection data.

Specifically, in this instance, the training graph will comprise a graph of “customer” and “vendor” type nodes connected via “sells to” and “buys from” type edges, along with “invoice” type nodes connected to certain “customer” and “vendor” type nodes, via “sends” and “receives” type edges. Each “invoice” type node will be supplemented by a GL code property, and each “customer” and “vendor” type edge will be supplemented by a “business type” property.

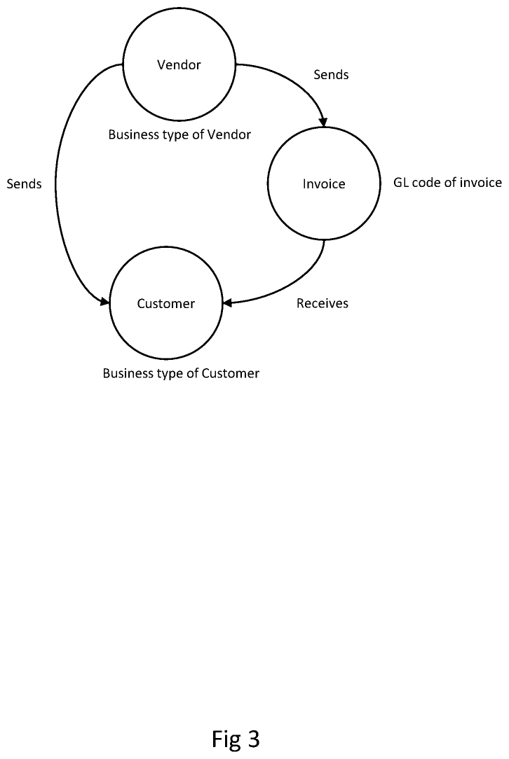

These types of nodes and edges and supplemented data are depicted in FIG. 3. Typically, the training graph will comprise many such interconnected “customer”, “vendor” and “invoice” type nodes.

As described above, the AI specialist will also input graph model configuration data to the user interface 103 which specifies graph model parameters which include, at least, the output to be produced by the graph model.

In this example, the graph model configuration data would specify that the graph model is to be trained and optimised to predict GL codes. In other words, generate an output variable indicative of a predicted GL code. In this instance, this graph model configuration data may specify all of the possible different GL codes that could be associated with an invoice (e.g. all the possible GL codes). As described above, the graph model configuration data may comprise further parameters.

At the fifth step the graph model configuration data and the training graph are communicated from the training graph generation module 102 to the graph model training module 106 which performs the graph model training protocol.

As described above, during a first phase, the graph model is configured. In this instance, the graph model training module 106 will configure the input layers of the graph model to receive a graph of the type defined in the training graph and configure the graph model to produce an output variable which is one of the number of possible GL codes defined in the graph model configuration data. As described above, further graph model configuration parameters may be applied at this stage.

During the second phase, the graph model training module 106 trains the configured graph model using the training graph an input. Specifically, some or all of the training graph is repeatedly input to graph model to generate an output which is a prediction of the GL code associated with a given invoice node based on the “business type” property of nodes connected to the node associated with the vendor who sent the invoice, and the “business type” property of nodes connected to the node associated with the customer who received the invoice. Each time this occurs, the output is analysed, and the weights of the graph model are updated to minimise a loss function.

More specifically, typically, during each pass, a forward propagation operation is performed during which the graph model training module 106 applies Graph Convolutional Network (GCN) layers to the features of the nodes and edges from the training graph. These layers aggregate and transform these features, creating a transformed representation internal to the graph model that is used for making predictions—specifically, for estimating the GL codes of “invoice” nodes. A loss function, such as mean squared error, measures the difference between the predicted and actual GL codes.

The graph model training module 106 typically then performs a backpropagation operation to adjust internal parameters like weights and biases, minimising the calculated loss. Stochastic gradient descent (SGD) is, or similar suitable technique can be employed for this optimisation step.

The training process continues until a pre-defined evaluation metric, such as accuracy or F1 score, indicates a satisfactory level of performance.

Once the graph model has reached a satisfactory level of performance, at the sixth step, S206, the trained model can then be deployed to a system for predicting GL codes, for example a module of a larger system for undertaking accounts payable operations.

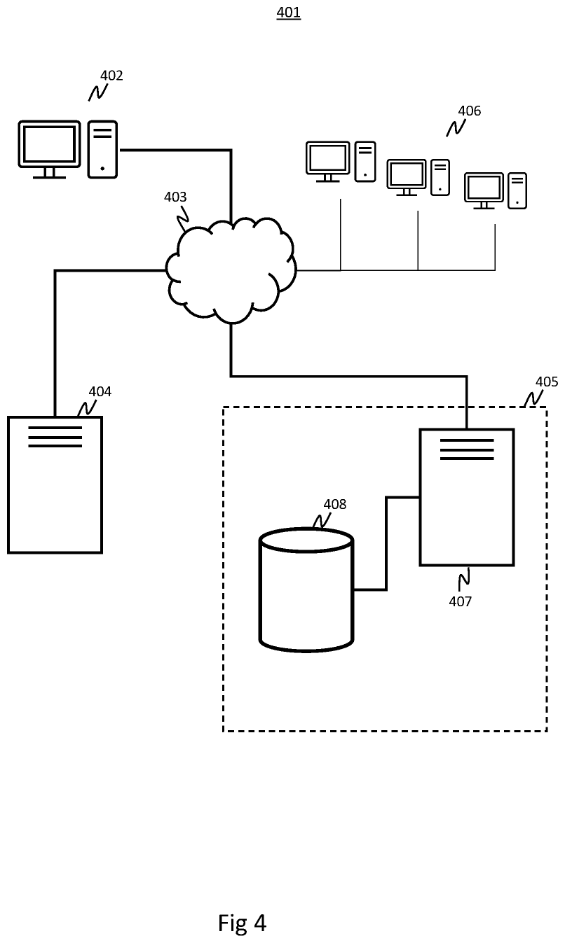

As the skilled person will understand, the system depicted in FIG. 1 can be implemented in any suitable way. FIG. 4 provides A simplified schematic diagram depicting an example implementation of the system.

FIG. 4 shows a system 401 comprising an operative device 402 connected via a data network 403 to a computer system 404. The system 401 further comprises an accounting system 405 which is also connected to the data network 403 and a plurality of user devices 406 also connected to the data network 403.

The accounting system 405 is configured to provide accounting services to the plurality of user devices 406.

The accounting system 405 comprises a further computing system 407 and data storage 408.

The computer system 404 is configured to implement functionality providing the training graph generation module 102, graph model training module 106 and deployment module 107.

The further computing system 407 is configured to run a software system providing accounting services to the plurality of user devices 406, for example as a “cloud computing” which users of the plurality of user devices 406 access via suitable software running on the plurality of user devices 406, for example web browser software. During operation, the software system is configured to maintain the first database 104 containing a network graph and the second database 105 contained related accounting data on the data storage 408.

The further computing system 407 has running thereon functionality for running one or more graph models, trained, and deployed in accordance with the techniques described above, and configured to receive graph queries to perform data processing tasks for performing one or more accounting tasks.

For instance, in keeping with the example described above, invoice data might be received from one of the plurality of user devices 406 identifying an invoice. Functionality running on the further computing system 407 may be configured to retrieve the invoice, identify from the invoice a vendor associated with the invoice and a customer associated with the invoice, and then retrieve from the first database 104 data identifying further parties with whom the vendor and customer have relationships, and retrieve from the second database 105 data identifying the nature of the business of these other parties. This data is then used to generate a graph model query which is input to a graph model, trained in accordance with the example described above, to predict a GL code associated with the invoice. This GL code can then be used to perform a GL code allocation task, associating the invoice with the predicted GL code.

The operative device 402 can be provided by any suitable computing device, for example personal computer, tablet or any other suitable computing device capable of providing a suitable interface via which an AI specialist can provide the training instruction data. The data network 403 connecting the operative device 402, computer system 404, accounting system 405 and plurality of user devices 406 is typically provided by the internet but can be provided by any suitable data network or combination of data networks. The computer system 404 can be provided by any suitable computing system comprising one or more computing devices capable of performing the data processing and graph model training functions of the training graph generation module 102, graph model training module 106 and deployment module 107. Similarly, the further computing system 407 can be provided by any suitable computing system comprising one or more computing devices capable of performing the data processing and data storage tasks associated with providing the accounting services to the plurality of user devices 406 and running one or more graph models. The first database 104 and second database 105 implemented on the data storage 408 can use any suitable database technology, for example any one of, or suitable any combination of, relational databases, NoSQL databases, graph databases. Advantageously, the first database 104 may be implemented as a suitable form of graph database which is well-suited for storing the network graph.

The functionality running on the computer system 404 and accounting system 405 in typical examples is provided by software programmed and deployed using any suitable technique, for example developed in Python, Java or C++ and deployed as monolithic implementations or as a plurality of microservices. However, as the skilled person will understand, some or all of this functionality may be run on dedicated hardware, configured specifically to implement the functionality in question. In particular, aspects of the technique associated with training and running graph models may be implemented on specialised hardware optimised to perform these functions.

The implementation depicted in FIG. 4 is just one example of the way examples of the invention could be implemented. As the skilled person will understand, other implementations, in particular other hardware and software architectures are possible, in particular implementations in which the functionality running on the 404// and the 405// are implemented as part of the same system on one or more computing devices.

Examples of the invention can train and deploy any suitable type of graph model to perform data processing operations associated with accounting tasks. For example, graph models based on any one of the following types of graph networks: graph neural networks; graph convolutional networks; graph attention networks; graph autoencoders; graph recurrent neural networks; graph generative adversarial networks; Bayesian graph neural networks; causal graph networks; differentiable graph networks; symbolic graph networks, and relational graph networks.

In the illustrative examples provided above, embodiments of the invention have been described in terms of generating training graphs for training graph models to perform the data processing operations associated with predicting a GL code from data extracted from an invoice.

However, the skilled person will understand that examples of the invention can be used to train and deploy graph models to perform data processing operations associated with any suitable accounting task in which an output variable may correlate with relationship data. For example, a graph model could be trained and deployed in: an invoice verification function for verifying invoices, where the expected accuracy of an invoice might correlate with the historical relationship between the supplier and purchaser; a payment forecasting function for forecast payment times, where payment times correlate with the historical relationship between a company and its clients; an expense or cost classification function for classify costs or expenses, where the relationship between expense or cost types and departments correlate to expense or cost categorisation; a fraud detection function, where transaction patterns and relationships with certain entities correlate with potential fraudulent activities; a credit risk assessment function where, relationship data of entities correlates with credit risk, and so on.

In certain examples, embodiments of the invention may be employed to train graph models to perform data processing tasks associated with a broader range of financial management tasks such as money laundering detection, cash flow forecasting, credit scoring, portfolio management (understanding and exploiting the complex relationships between different assets), and risk management.

All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

It will be appreciated that various embodiments of the present disclosure have been described herein for purposes of illustration, and that various modifications may be made without departing from the scope of the present disclosure. Accordingly, the various embodiments disclosed herein are not intended to be limiting, with the true scope being indicated by the following claims.

1. A computer implemented method of generating a graph model for performing a data processing operation associated with an accounting task, said method comprising the steps of:
a) receiving training instruction data from an interface identifying:
a subset of nodes and edges, said edges interconnecting said nodes, from a network graph representing a plurality of relationships, and
an output variable associated with the accounting task for the trained graph model to predict;
b) retrieving the subset of nodes and edges from the network graph;
c) retrieving one or more accounting data records associated with one or more of the subset of nodes and edges;
d) generating a training graph comprising the retrieved subset of nodes and edges supplemented by the accounting data;
e) training a graph model to predict the output variable using the training graph, and
f) deploying the training graph to a system for performing the data processing operation associated with the accounting task.

2. A method according to claim 1, wherein each node is representative of an entity.

3. A method according to claim 1, wherein each edge is representative of a relationship or interaction between entities associated with nodes that the edge interconnects.

4. A method according to claim 3, wherein each node has a type, said type indicative of a characteristic associated with entity of which the node is representative.

5. A method according to claim 4, wherein each edge has a type, said type indicative of a characteristic associated with the relationship of interaction with which the edge is associated.

6. A method according to claim 5, wherein the retrieved accounting data records define further accounting properties associated with the entities to which the nodes relate.

7. A method according to claim 6, wherein the retrieved accounting data records define further accounting properties associated with the interactions or relationships between entities to which the edges relate.

8. A method according to claim 2, wherein the entity to which each node relates is one of a party or an accounting data object.

9. A method according to claim 1, wherein the training instruction data specifies parameters of the graph model and step e) comprises a preliminary graph model configuration step comprising:
setting one or more parameters of the graph model in accordance with the graph model configuration data.

10. A method according to claim 9, wherein the preliminary graph model configuration step further comprises:
configuring an input of the graph model in accordance with the subset of nodes and edges defined in the training instruction data.

11. A method according to claim 10, wherein the preliminary graph model configuration step further comprises:
configuring an output of the graph model in accordance with the output variable defined in the training instruction data.

12. A method according to claim 5, wherein the training instruction data identifies the subset of nodes and edges by specifying one or more node types and one or more edge types and the step of retrieving the subset of nodes and edges from the network graph comprises retrieving nodes and edges of the specified types from the network graph.

13. A method according to claim 1, wherein the interface runs on a computing device configured to receive the training instruction data from an operative.

14. A method according to claim 1, wherein the graph model is one of: a graph neural network; graph convolutional network; graph attention network; graph autoencoder; graph recurrent neural network; graph generative adversarial network; Bayesian graph neural network; causal graph network; differentiable graph network; symbolic graph network; relational graph network.

15. A computer system for generating a graph model for performing a data processing operation, associated with an accounting task, said system comprising a training graph generation module and a graph model training module, wherein said training graph generation module is configured to:
receive training instruction data from an interface identifying:
a subset of nodes and edges, said edges interconnecting said nodes, from a network graph representing a plurality of relationships, and
an output variable associated with the accounting task for the trained graph model to predict;
retrieve from data storage the subset of nodes and edges from the network graph;
retrieve from data storage one or more accounting data records associated with one or more of the subset of nodes and edges, and
generate a training graph comprising the retrieved subset of nodes and edges supplemented by the accounting data, wherein
the graph model training module is configured to receive the training graph and train a graph model to predict the output variable using the training graph, said training graph thereby deployable to a system for performing the data processing operation associated with the accounting task.

16. A system according to claim 15, wherein each node is representative of an entity.

17. A system according to claim 15, wherein each edge is representative of a relationship or interaction between entities associated with nodes that the edge interconnects.

18. A system according to claim 17, wherein each node has a type, said type indicative of a characteristic associated with entity of which the node is representative.

19. A system according to claim 18, wherein each edge has a type, said type indicative of a characteristic associated with the relationship of interaction with which the edge is associated.

20. A system according to claim 19, wherein the retrieved accounting data records define further accounting properties associated with the entities to which the nodes relate.

21. A system according to claim 20, wherein the retrieved accounting data records define further accounting properties associated with the interactions or relationships between entities to which the edges relate.

22. A system according to claim 16, wherein the entity to which each node relates is one of a party or an accounting data object.

23. A system according to claim 15, wherein the training instruction data specifies parameters of the graph model and the graph model training module is configured to perform a preliminary graph model configuration procedure comprising:
setting one or more parameters of the graph model in accordance with the graph model configuration data.

24. A system according to claim 23, wherein the preliminary graph model configuration procedure further comprises:
configuring an input of the graph model in accordance with the subset of nodes and edges defined in the training instruction data.

25. A system according to claim 24, wherein the preliminary graph model configuration procedure further comprises:
configuring an output of the graph model in accordance with the output variable defined in the training instruction data.

26. A system according to claim 19, wherein the training instruction data identifies the subset of nodes and edges by specifying one or more node types and one or more edge types and the step of retrieving the subset of nodes and edges from the network graph comprises retrieving nodes and edges of the specified types from the network graph.

27. A system according to claim 15, further comprising a computing device on which the interface runs and configured to receive the training instruction data from an operative.

28. A system according to claim 15, wherein the graph model is one of a graph neural network; graph convolutional network; graph attention network; graph autoencoder; graph recurrent neural network; graph generative adversarial network; Bayesian graph neural network; causal graph network; differentiable graph network; symbolic graph network; relational graph network.

29. A computer program which when run on a computing system controls the computing system to perform a method according to claim 1.
